(19) United States
(12) Patent Application Publication
(10) Pub. No.: US 2020/0133028 A1
(43) Pub. Date: Apr. 30, 2020

(54) SYSTEM FOR CUSTOM MANUFACTURING FILM FOR LENSES OF EYEWEAR

(71) Applicant: Moetion Technologies LLC, Caledonia, MI (US)

(72) Inventors: Benjamin Moes, Caledonia, MI (US); Paul Edwin Moes, Kentwood, MI (US); Alexzander C. Williams, Mequon, WI (US); Blake R. Gregory, Howell, MI (US); Daniel Chang Garcia, Grand Rapids, MI (US); Scott E. Cooper, Orland Park, IL (US); William J. Oakes, Princeton, MN (US)

(21) Appl. No.: 16/403,234

(22) Filed: May 3, 2019

Related U.S. Application Data
(60) Provisional application No. 62/751,356, filed on Oct. 26, 2018.

(51) Int. Cl. G02C 7/16; G06Q 20/08

(52) U.S. Cl. CPC G02C 7/165; G06Q 20/08

(57) ABSTRACT

A system for custom manufacturing a film to be temporarily applied to lenses of eyewear is provided. The system includes a measuring unit for measuring dimensions of the lenses, a user-interface for receiving user input pertaining to desired properties of the film, and a film-cutting unit for cutting the film according to the dimensions of the lenses. The system can also include a control unit that is configured to receive the dimensions of the lenses from the measuring system, and transmit information pertaining to the dimensions of the lenses to the film-cutting system. The system can also include a payment unit for receiving payment from a user.

### CROSS REFERENCE TO RELATED APPLICATION

This application claims the benefit of U.S. Provisional Application 62/751,356, which was filed on Oct. 26, 2018, the disclosure of which is hereby incorporated by reference.

### BACKGROUND OF THE INVENTION

### 1. Field of the Invention

The present disclosure relates generally to eye protection wear; and, in particular, to a system for custom manufacturing film which can be selectively and individually attached to lenses of eyewear.

### 2. Description of the Prior Art

Individuals who wear prescription eyeglasses or corrective eyeglasses often carry an additional pair of glasses for sun protection. Obtaining two or more pairs of eyeglasses for use under different conditions is costly particularly in the case of prescription eyeglasses that are fabricated to meet the specialized needs of the particular person. The second pair of eyeglasses is often bulky, particularly if carried within a case, and is subject to damage if not carried or stored in a case. It has been found that often one of the two pairs of glasses (e.g., prescription eyeglasses or sunglasses) is often lost, damaged, or stolen when the user takes one pair off and puts the other pair on. In addition, individual who have prescription sunglasses often forget to wear them, or simply choose not to on certain days out of convenience. As a result, many of these individuals experience discomfort, squinting, or excessive brightness when outside in direct or partial sunlight.

To remedy such inconvenience, various prescription eyeglasses have been proposed including those which use dimmer lenses to automatically adjust color gradations to give a function of sunglasses. For instance, some prescription glasses are specifically structured to automatically change or implement tinting when exposed to different levels of sun or shade. Particularly, the lenses may be configured to automatically tint when exposed to the sun and automatically revert back to being transparent when not exposed to the sun. These types of lenses are often extremely expensive and can, in many cases, malfunction or otherwise not operate in the intended manner or desired manner. For example, some individuals may not want the lenses to tint at certain times, however, there is no control over when the lenses tint.

In the prior art there are also attachments that can be temporarily clipped onto a person's basic vision-correcting eyeglasses at times when reduced light intensity or some other vision modification is needed. It is generally simpler and more economical to make use of attachments of the type that can be temporarily clipped onto the person's basic vision, correcting eyeglasses at times when reduced light intensity or some other vision modification is needed. Such eyeglasses include those provided with clip-on sunglasses, and those with temple-less sunglasses positioned inside thereof. However, when the eyeglasses include clip-on sunglasses, it is troublesome to move the sunglasses up and down, and when the sunglasses are not used, they stay in an up position, which is a nuisance and fashionable undesirable. On the other hand, the temple-less sunglasses are not stable since they simply hang on the eyeglasses. Also, temple-less sunglasses are undesirable because they are positioned inside of the eyeglasses.

One other technique being employed is to apply a temporary film on the lenses of the eyewear to reduce transmission of light therefrom. For example, U.S. Pat. No. 6,113,233 A ('233 patent) discloses a lens cover system. The lens cover system includes a sheet of material suitable for use in covering a first lens, a pin suitable for use in making a first plurality of holes in the sheet of material around the perimeter of the first lens, and a pair of scissors for cutting the sheet of material along the first plurality of holes thereby creating a first lens cover. The lens cover system also includes a storage apparatus for storing each lens cover. This proposed solution of using low cost polymer films that adhere to the prescription lenses is generally satisfactory in most cases. However, the proposed solution requires the films to be measured and cut by hand to be customized for lenses of different sizes of eyewear. This manual process is time consuming and labor intensive, making it an inconvenient solution that is unattractive to consumers.

The present invention has been proposed to remedy the above disadvantages, and it is an object of the present invention to provide a system for custom manufacturing a film to be temporarily applied to lenses of eyewear which is fast, efficient, and affordable.

### SUMMARY

In an aspect, a system for custom manufacturing a film to be temporarily applied to lenses of eyewear is provided. The system comprises a measuring unit for measuring dimensions of the lenses. The system also comprises a user-interface for receiving user input pertaining to desired properties of the film. The system further comprises a film-cutting unit for cutting the film according to the dimensions of the lenses.

In one or more embodiments, the system further comprises a control unit that is configured to receive the dimensions of the lenses from the measuring system, and transmit to the film-cutting system information pertaining to the dimensions of the lenses.

In one or more embodiments, the system further comprises a tray arranged in the measuring unit for receiving and holding the eyewear therein.

In one or more embodiments, the system further comprises a payment unit for receiving payment from a user.

In one or more embodiments, the film is a multilayer film.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a more complete understanding of the exemplary embodiments of the present disclosure, reference is now made to the following descriptions taken in connection with the accompanying drawings, in which:

FIG. 1 illustrates a schematic block diagram of a system for custom manufacturing a film to be temporarily applied to lenses of eyewear, in accordance with one or more embodiments of the present disclosure;

FIG. 2 illustrates a diagrammatic view of a measuring unit of the system of FIG. 1, in accordance with a first embodiment of the present disclosure;

FIG. 3 illustrates a diagrammatic view of a measuring unit of the system of FIG. 1, in accordance with a second embodiment of the present disclosure;

FIG. 4 illustrates a diagrammatic view of a measuring unit of the system of FIG. 1, in accordance with a third embodiment of the present disclosure;

FIG. 5A illustrates a diagrammatic view of a measuring unit of the system of FIG. 1, in accordance with a fourth embodiment of the present disclosure;

FIG. 5B illustrates a side view of the measuring unit of FIG. 5A;

FIG. 6 illustrates a diagrammatic view of a measuring unit of the system of FIG. 1, in accordance with a fifth embodiment of the present disclosure;

FIG. 7 illustrates a diagrammatic view of a measuring unit of the system of FIG. 1 including a heat source; and

FIG. 8 illustrates a diagrammatic view of a film-cutting unit of the system of FIG. 1, in accordance with one or more embodiments of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced item. Moreover, various features are described which may be exhibited by some embodiments and not by others. Similarly, various requirements are described which may be requirements for some embodiments but not for other embodiments.

The embodiments are described herein for illustrative purposes and are subject to many variations. It is understood that various omissions and substitutions of equivalents are contemplated as circumstances may suggest or render expedient, but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

The present disclosure relates to a system that produces custom temporary films for eyewear users including: (1) an optical measurement unit for determining the dimensions of a set of eyeglasses; (2) a control unit that translates the dimensions to a cutting machine; (3) a film with optical properties that enhance eyewear; (4) an integrated film-cutting unit for cutting the film and dispensing the film to the user; (5) and a payment and user interface. The system is configured to custom measure the eyewear and cuts pieces of film to cover the optically clear portions of the eyewear. Typically, this film is a tinted film which reduces the optical transmissivity of the eyewear creating sunglasses or other light-reducing eyewear. Most often, these films are adhered to prescription eyewear using a temporary adhesive, electrostatic attraction, or any other suitable technique.

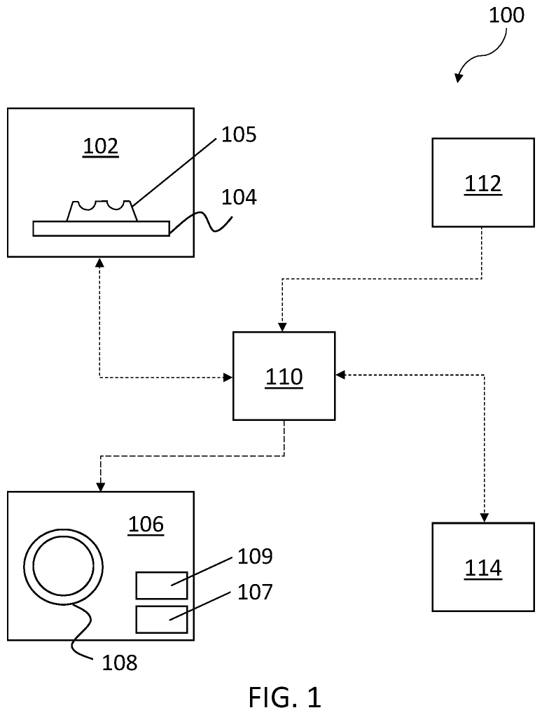

Referring to the drawings, FIG. 1 illustrates a schematic block diagram of a system (generally referred by the numeral 100) for custom manufacturing a film to be temporarily applied to lenses of eyewear, in accordance with an embodiment of the present disclosure. In other words, the system 100 provides and dispenses custom films that can be adhered to the eyewear. Hereinafter, the term “eyewear” has been used interchangeably with the terms “glasses” and the like without any limitations. The films dispensed are adhered to eyewear for a number of different reasons, including to create temporary sunglasses, by including color filters or polarizers to create glasses for 3D film or television viewing, for use in an industrial site by including ultra-violet (UV) rays filtering, or to provide decorate features for eyeglass wearers. Herein, the system 100 may be in the form of a kiosk or vending machine located in a public outdoor place or areas where users may want to customize their eyewear. For instance, the system 100 may be installed in an optometrist's office, a movie theater, an industrial site, or an outdoor sporting arena.

The system 100 of the present disclosure includes a measuring unit 102 for measuring dimensions of the lenses of the eyewear (not shown in FIG. 1). The measuring unit 102 is an optical measuring unit (as discussed later). A tray 104 may be arranged in the measuring unit 102 for receiving and holding the eyewear therein. The system 100 also includes a film-cutting unit 106 for cutting a film which is generally provided on a film roll 108. The film-cutting unit 106 cuts the film according to the dimensions of the lenses of the eyewear (as measured by the measuring unit 102). Details about the measuring unit 102 and the film-cutting unit 106 have been provided in the subsequent paragraphs, as well as the corresponding components which include the tray 104 and the film roll 108.

In one or more embodiments, the system 100 includes a control unit 110 that is configured to receive the dimensions of the lenses from the measuring system 102, and transmit information to the film-cutting system 106 pertaining to the dimensions of the lenses. The control unit 110 may include at least one processor and at least one non-transitory memory including computer program code instructions. The processor may be embodied in a number of different ways. For example, the processor may be embodied as one or more of various hardware processing means, such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (A/ICU), a special-purpose computer chip, or the like. As such, in some embodiments, the processor may include one or more processing cores configured to perform independently. A multi-core processor may enable multiprocessing within a single physical package. Additionally, or alternatively, the processor may include one or more processors configured in tandem via the bus to enable independent execution of instructions, pipelining and/or multithreading. The memory may be non-transitory and may include, for example, one or more volatile and/or non-volatile memories. In other words, for example, the memory may be an electronic storage device (for example, a computer readable storage medium) comprising gates configured to store data (for example, bits) that may be retrievable by a machine (for example, a computing device like the processor). The memory may be configured to store information, data, content, applications, instructions, or the like, for enabling the apparatus to carry out various functions in accordance with an example embodiment of the present invention. For example, the memory could be configured to buffer input data for processing by the processor. Additionally, or alternatively, the memory could be configured to store instructions for execution by the processor.

The processor (and/or co-processors or any other processing circuitry assisting or otherwise associated with the processor) may be in communication with the memory via a bus for passing information among components of the system 100. The processor may be configured to execute instructions stored in the memory or otherwise accessible to the processor. Additionally, or alternatively, the processor may be configured to execute hard coded functionality. As such, whether configured by hardware or software methods, or by a combination thereof, the processor may represent an entity (for example, physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor specific device (for example, a mobile terminal or a fixed computing device) configured to employ an embodiment of the present invention by further configuration of the processor by instructions for performing the algorithms and/or operations described herein. The processor may include, among other things, a clock, an arithmetic logic unit (ALU) and logic gates configured to support operation of the system 100.

In one or more embodiments, the system 100 also includes a user-interface 112 for receiving user input pertaining to desired properties of the film. The user-interface 112 may include any device suitable for providing information to or for receiving inputs from one or more users of the system 100. In some examples, the user interface 112 may include user input devices, including, for example, a touchscreen, microphone, keyboard, pointer devices, track wheels, cameras, knobs, buttons, etc. With such input devices, a user may be able to provide information inputs or commands to the system 100 by typing instructions or information, providing voice commands, selecting menu options on a screen using buttons, pointers, or eye-tracking capabilities, or through any other suitable techniques for communicating information to the system 100. The user interface 112 may also include user output devices, including, for example, a display, one or more speakers, a tactile device, and/or any other devices for providing output information to the user. The user interface 112 may be equipped with one or more processing devices configured to provide and receive information to or from a user and process that information. In a preferred embodiment, the user interface 112 may be in the form of a touch screen display.

Further, in one or more embodiments, the system 100 includes a payment unit 114 for receiving payment from a user. The payment unit 114 controls and validates payments from one or more payment interfaces. In one or more examples, the payment unit 114 offers multiple payment devices, including a conventional coin acceptor, a conventional credit or debit card reader, and banknote acceptor, and an electronic payment interface. Such electronic payment interface may be of the type that enables billing to a user's mobile telephone account or other electronic payment system known in the art by connection to an appropriate electronic payment system. It will be understood that any one or more of the payment interfaces may be implemented by the payment unit 114 of the present disclosure.

It may be understood that the user would purchase or order custom films by first prompting the system 100 to begin through the user interface 112. As discussed, the user interface 112 may be a touchscreen, keyboard, keypad, web interface on a remote device, or any other type of standard user interface. In use, the user selects the type of film desired to be applied to the eyewear. The user is then prompted to place the eyewear in the measuring unit 102 in the dedicated location, and the measuring unit 102 then measures the size and shape of the lenses of the eyewear. The measuring unit 102 then cuts and dispenses the film(s) according to the measured shape of the lenses. The user then removes any temporary backing from the film (if provided) and adheres the films to the eyewear lenses. In some examples, the backing material may be designed with a textured surface or from a textured material, such as cloth or fabric, and could be used as a cleaning material to wipe dirt and debris from the surface of the eyewear lenses.

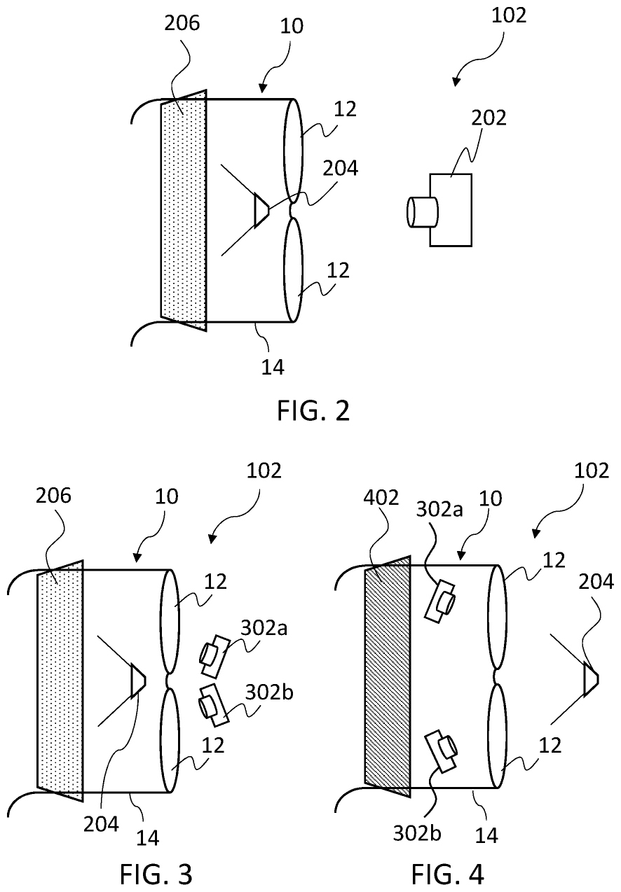

As discussed, the present system 100, being implemented to create the custom films, utilizes the measuring unit 102 to determine the size and shape of the films to be cut for eyewear. For this purpose, the eyewear, such as eyewear 10 (as shown in FIG. 2), is placed in the measuring unit 102 and held in place while the measuring unit 102 determines the dimensions of the eyewear 10. Specifically, the measuring unit 102 determines the dimensions of lenses 12 of the eye-wear 10, supported by a frame 14 therein (as shown in FIG. 2). In the present examples, the eyewear 10 may be held in place in the measuring unit 102 through the use of a tray (such as, the tray 104 of FIG. 1). The measuring unit 102 has the tray 104 as a dedicated location for the eyewear 10 to be inserted, where the measurement of the dimensions of the eyewear 10 takes place. Alternatively, the eyewear 10 may be held in place in a shelf or a drawer, or may be worn by the user while taking the measurements. It may be appreciated that the tray 104 may be a regular planar tray, which is well known in the art and of suitable dimensions and preferably having provisions to accommodate and support the eyewear 10 therein.

In general, the measuring unit 102 can include a camera or set of cameras to determine the outline of the frames 14 and lenses 12 of the eyewear 10. The one or more cameras uses light from a light source to determine the size and shape of the frames 14 so long as the lenses 12 are translucent or near translucent. In the event that the frames 14 do not extent around the lenses 12, the one or more cameras may also include an infrared light source to determine the size and shape of the lenses 12, as most lenses do not transmit infrared light. To detect the infrared light, the measuring unit 102 may use two cameras; one for infrared and one for visible light. Alternatively, a camera having an infrared filter can be moved in front of the imager for the visible light measurements. Optionally, ultraviolet (UV) light may also be used to increase the contrast from the reflected background light and areas blocked by the frames. Narrowband UVA and UVB light are transmitted through the lenses while blocked by the frames, but because UV light does not reflect from as many surfaces as broad-spectrum white light, the directivity of the UV light can be more easily controlled when using visible light and near-visible light detection of frames. In addition, an eyewear-holding fixture 105 may optionally be included which includes the screen or other visible-blocking shield to cover the earpieces of the frame in order to assist the camera in identifying and isolating the lenses 12 from the frame.

In such an embodiment, the measuring unit 102 would first image the eyewear 10 by projecting infrared light through and around the eyewear 10 with the imager capturing the resulting infrared image with the infrared filter removed from the optical path. The measuring unit 102 would then project visible light through and around the lenses 12 with the infrared filter moved in front of the camera sensor to remove any infrared light. Alternatively, the measuring unit 102 may include a light shield which blocks external light from entering the measurement area, preventing ambient light from impacting the measurements. The measuring unit 102 may include two cameras with one for each lens 12. The cameras may be located in front of the lenses 12 aligned near the center of the eyewear 10 pointed outwards towards the lenses 12 so that the image of the visible light is not impacted by any nosepieces in the eyewear 10. Alternatively, the cameras may be located behind the eyewear 10 near the earpieces with the cameras angled towards the nosepieces, wherein the visible light source is located in front of the eyewear 10.

Referring now to FIG. 2, the measuring unit 102 is illustrated in accordance with a first embodiment of the present disclosure. In the first embodiment, the measuring unit 102 includes an imaging device, such as a camera 202. In the present examples, the camera 202 may utilize an image processing system to interpolate the dimensions of the lenses 12. In one example, the measuring unit 102 may use visible light, infrared light, ultraviolet light, or any combinations thereof to determine the size and shape of the lenses 12. In another example, the measuring unit 102 may use both visible light and infrared light, wherein the infrared light is used to determine the outline of the eyewear 10 and lenses 12 together (as most lenses block infrared light) and visible light to determine the outline of the lenses 12 (regardless of whether or not the lenses 12 are surrounded entirely by frames 14). This would allow the measuring unit 102 to determine the size of the lenses 12 themselves so that the piece of cut film would not cover or overlap the frames 14 when applied to the eye-wear 10.

In the present embodiment, the measuring unit 102 may use the single camera 202 that contains a movable infrared filter (not shown). This movable filter can be moved in front of the camera 202 to remove infrared light during the visible light measurements and moved out of the way during the infrared light measurements. This measuring unit 102 may use infrared and visible light sources, or, alternatively, a single light source 204 (as shown) capable of generating both infrared and visible light. The light source 204 is mounted behind the lenses 12 when placed in the measuring unit 102, with the camera 202 located in front of the lenses 12. The measuring unit 102 may also use a reflective surface 206 behind the eyewear 10 to provide a uniform light source allowing for a more accurate measurement by optical sensors of the camera 202. In the present examples, the reflective surface 206 may be configured to reflect visible light, infrared light, or both.

Referring now to FIG. 3, the measuring unit 102 is illustrated in accordance with a second embodiment of the present disclosure. In the said second embodiment, the measuring unit 102 includes two cameras 302a and 302b; one for infrared light and one for visible light. In an example, the cameras 302a and 302b may be part of a dual-mounted camera. It will be appreciated that the cameras 302a and 302b may be aligned near the lenses 12 towards the center of the eyewear 10 pointing diagonally outwards towards the front of the lenses 12. This allows the cameras 302a and 302b to determine the size and shape of the lenses 12 without the nosepieces of the frame 14 being located between the corresponding light source 204 and the cameras 302a and 302b. Otherwise, the nosepieces of the frame 14 may show up in the measurements and may incorrectly be included in the cut samples (discussed later).

Referring now to FIG. 4, the measuring unit 102 is illustrated in accordance with a third embodiment of the present disclosure. In the third embodiment, the measuring unit 102 has the cameras 302a and 302b located behind the eyewear 10 near the earpieces, with the cameras 302a and 302b angled towards the nosepieces. This embodiment is particularly useful for eyewear 10 that has relatively large nosepieces. In other arrangements, large nosepieces can potentially block portions of the lenses 12, which would result in the film cutout not including those blocked portions. However, by placing the cameras 302a and 302b near the earpieces and pointing the cameras 302a and 302b toward the nosepieces, then the full surface of both lenses 12 can be seen even when larger nosepieces are present. Herein, the visible light source 204 may be located in front of the eyewear 10. Further, the measuring unit 102 of FIG. 4 employs a light-blocking surface 402, or some reference background image, behind the eyewear 10 to prevent ambient light from disturbing the sensors in the cameras 302a and 302b, and allowing for a more precise measurement. Some or all of the above mentioned embodiments may require the use of a light-blocking surface, such as the light-blocking surface 402, behind the eyewear 10 to prevent ambient light from disturbing the sensors in the camera(s) and allowing for a more precise measurement.

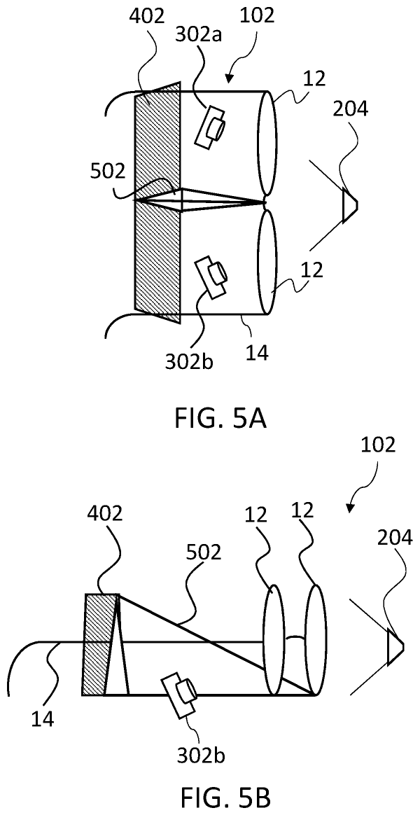

Referring now to FIGS. 5A and 5B, the measuring unit 102 is illustrated in accordance with a fourth embodiment of the present disclosure. In the fourth embodiment, the measuring unit 102 has the cameras 302a and 302b located behind the eyewear 10 near the earpieces, with the cameras 302a and 302b angled towards the nosepieces. Herein, the visible light source 204 may be located in front of the eyewear 10. Further, the measuring unit 102 has the light-blocking surface 402 behind the eyewear 10. In addition, the measuring unit 102 optionally includes an alignment guide 502 which may be placed in the area wherein the sample is retained by the tray 104 (or other contoured shape). The alignment guide 502 helps to align the eyewear 10 with the cameras 302a and 302b in the measuring unit 102. The alignment guide 502 may include a slanted center portion that aligns under the nosepiece or bridge of the eyewear 10 that forces the eyewear 10 forward and aligns the eyewear 10 symmetrically side-to-side within the measurement area of the measuring unit 102. It may be appreciated that such alignment guide 502 may be employed in any of the above described embodiments without departing from the scope of the present disclosure.

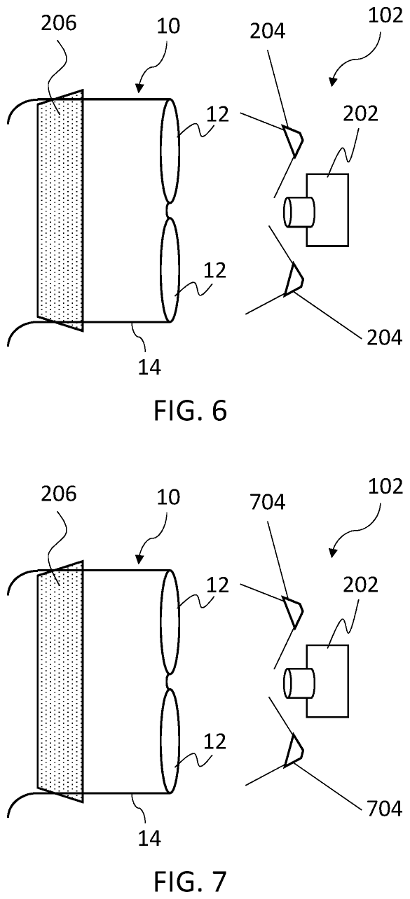

Referring now to FIG. 6, the measuring unit 102 is illustrated in accordance with a fifth embodiment of the present disclosure. In the fifth embodiment, the measuring unit 102 includes the camera 202. It will be appreciated that the camera 202 may be aligned near the lenses 12 towards the center of the eyewear 10 pointing towards the front of the lenses 12. In addition, the light source 204 is also positioned in front of the lenses 12 and aiming generally toward the center of the eyewear 10. Optionally, and as shown in FIG. 6, two or more light sources 204 are provided to minimize shadows and to ensure sufficient lighting is provided. Additional light sources 204 may be provided as needed.

In order to assist in locating and measuring the lenses 12, a parent-child image processing method can optionally be used in which the desired “child” image (i.e. the lenses 12) is located within the “parent” image (i.e. the frames 14 of the eyewear 10). In this regard, the frames 14 are first located in the image, and then the lenses 12 are located within the image of the frames 14. This can be accomplished using well-known edge detection filters such as a Laplacian filter or a Prewitt filter to provide high-contrast edge detection.

This can optionally be combined with thermal imaging, which is particularly helpful for partial-frame or frameless lenses 12. In this situation, and outer edge of the frames 14 and lenses 12 are located using reflected infrared light wherein a heating system includes a heat source 704 that heats the frames, such as shown in FIG. 7. Multiple heat sources 704 may optionally be provided to ensure evenly-applied heating to the frames 14 and lenses 12. The heated frames are then readily located using a temperature filter. This provides the “parent” image for subsequent analysis. Next, a visible light image is then captured of the eyewear 10 and the “parent” area from the thermal analysis is applied. The visible light image determines if any frames are present within the “parent” area, and the frames are subtracted from the image leaving the “child” image of the lenses 12, which in turn is measured to determine the geometry of the film 802.

Furthermore, in some examples, the measurement unit 102 may use a scaling factor to account for surface curvature of the lenses 12, wherein a larger curvature is used to scale the dimensions of the film to account for a larger surface area of the lenses 12 or the eyewear 10. In addition, the measurement unit 102 may utilize a 2-dimensional representation of the outline of the eyewear 10 or the lenses 12 to simplify the interpolation of the material dimensions. In some alternate embodiments, the measurement unit 102 may be a coordinate measuring machine (CMM) with a probe mounted to a controlling arm and sensor which uses physical contact with the eyewear 10, or specifically the lenses 12, being measured to determine its dimensions. In another embodiment, the measurement unit 102 may also be a laser-based system using either a grid-measurement system or moving laser system for measuring dimensions of the lenses 12 in the eyewear 10. Alternatively, some of the above described embodiments may employ a 3-dimensional measurement unit 102 which allows the material to be cut to fit a curved surface of the lenses 12. Such units are well known and thus have not been described herein for the brevity of the present disclosure.

Optionally, an image calibration system (not shown) may be provided to assist with calibrating the distance-measuring capabilities of the camera. The image calibration system can include a calibration object (such as a square, grid, or other image having known dimensions) on the tray 104. In order to ensure long-term accuracy in measuring the size of the lenses 12, the image calibration system can periodically calibrate the camera by measuring the distance to and/or the size of the calibration object. Alternatively, rather than providing the calibration object, patterns of images may be projected onto the lenses 12 to help the measuring unit 102 determine the distance to the lenses 12, as well as possibly the curvature and geometry of the lenses 12. The images may be lines, dots, or any other suitable predetermined pattern(s) that allows a distance measurement between the pattern(s) to provide a scaled determination of distance. For instance, as the distance between the patterns grows, the location is calculated to be closer as it fills more of the field of vision of the image sensor, and thus the pattern(s) are separated by more image pixels. The image calibration system can use visible light, infrared light, UV light, lasers, temperature projection systems, or any suitable combinations thereof.

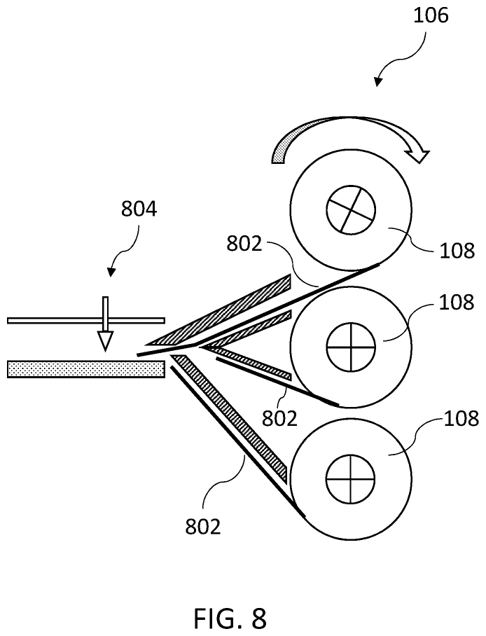

FIG. 8 illustrates a representation of the film-cutting unit 106 for cutting film 802 to be applied to the lenses 12 of the eyewear 10, in accordance with an embodiment of the present disclosure. The film 802 that is adhered to the eyewear 10 may be made from several different materials. In one embodiment, the film 802 may be a polymer-based film such as vinyl, polyethylene, or any other flexible thin-film polymer. In another embodiment, the film 802 may be made from a silicone-based material. In yet another embodiment, the film 802 may be made from several materials such as a metalized Mylar. In the present embodiments, the film 802 may be a single-layer film or a multi-layer film without any limitations. These films 802 may be used for reducing light transmissivity and/or for UV or IR light blocking such as for sunglasses; to provide additional image correction for scientific or industrial uses; or may be used for visual effects like 3D video projections for entertainment use. In some examples, the film 802 may have an optional backing material to prevent the film from adhering to undesired surfaces. For example, the backing material of the film 802 may also have a cloth-like texture that may be used to wipe the lenses 12 clean.

The film 802 may be stored within the film-cutting unit 106 in several different means. For example, as discussed, the film-cutting unit 106 can include one or more film rolls 108 correspondingly supporting a long sheet of film 802 thereon. The film-cutting unit 106 may employ mechanical or powered mechanisms to rotate the one or more film rolls 108 to feed the film 802 to a cutting mechanism 804. That is, in one example, the film 802 may be stored on a roll or several rolls which are fed into the material-cutting area through the use of a motor. Alternatively, in another example, the film 802 may be stored in trays or sheets that are fed into the cutting area using powered rollers.

The cutting mechanism 804 may use several different methods to cut the film 802. In one embodiment, the cutting mechanism 804 employs a blade with a positioning system to cut the film 802. In another embodiment, the cutting mechanism 804 employs a focused laser to melt or burn away an outline within the film 802 creating a piece of the desired shape. In another embodiment, the cutting mechanism 804 may employ a rotating cutting head, such as a CNC, to cut out the desired shape from the film 802. In yet another embodiment, the cutting mechanism 804 may employ a high-pressure water jet to cut the film 802 into the desired shape. In yet another embodiment, the cutting mechanism 804 may employ an oscillating cutting head, such as a scroll-saw type cutting blade, to cut the film 802. In still another embodiment, the cutting mechanism 804 may employ a small cutting head to puncture the film 802 repeatedly to create small holes creating a perforation around the outline of the desired shape, wherein a user can tear away the excess material. It is also to be understood that usage information about the cutting mechanism 804 and the film 802 can be stored, such as on the control unit 110, and then transmitted to a remote device to help determine when a new film roll 108 needs to be added to the system 110. This monitoring feature can also be used to help determine when the cutting mechanism 804 needs maintenance or to be replaced.

The film 802, which has been cut into the required dimensions, is then adhered to the lenses 12 of the eyewear 12 through several different methods. In one embodiment, the film 802 uses electrostatic attraction to adhere to the lenses 12 of the eyewear 10, allowing for temporary use. In another embodiment, the film 802 uses an adhesive that may be intended to be either permanent or temporary for adhering to the lenses 12 of the eyewear 10. In yet another embodiment, the film 802 may use tabs, clips, or other mechanical features that allow it to be affixed to the lenses 12 of the eyewear 10.

It may be contemplated by a person skilled in the art that the present system 100 may use only one embodiment of film material, film adhesive, film type, or other characteristics of the desired custom film. Alternatively, the system 100 may allow for several different options including the opacity of the film 802, the means of adhering the film 802, or other user desired options. This may be accomplished by having several materials loaded into the system 100 at a time with a means to switch from one material to another. Different cutting patterns may also be used to provide users with various means of attaching the films to their eyewear such as tabs that can be wrapped around or attached to parts of the eyewear other than the lenses. These options may be user selectable in the user interface 112 of the system 100.

It may be particularly viable to use electrostatic attraction to adhere the film 802 to the lenses 12. This is especially true when the film 802 comprises vinyl, which is particularly prone to building up a static charge. However, it is recognized that an overabundance of static charge is undesirable, as is an insufficient amount of static charge. Therefore, a discharge mechanism 107 may optionally be provided with the film cutting unit 106 to assist with decreasing the amount of static charge on the film 802. The discharge mechanism 107 can be provided in the form of a grounded surface or cutting head, ionized forced air, capacitive charge/discharge plates, and so forth. Alternatively, increasing the amount of static charge on the film 802 may be accomplished by optionally providing a conductive or capacitive charge plate, an ionized air blower, or any other suitable type of electrostatic generator. Yet another option is to provide a backing material to the film 802 such that when the backing material is removed from the film 802, it causes a buildup of static charge immediately prior to the film 802 being adhered to the lenses 12.

In addition, when electrostatic charge is used to adhere the film 802 to the lenses 12, then a static charge measurement system 109 can optionally be provided to measure the amount of static charge on the film 802 and/or the lenses 12. The amount of static charge on the film 802 will vary depending upon a number of factors, such as the ambient relative humidity and temperature. In use, the static charge measurement system 109 will measure the amount of static charge on the film 802 and/or the lenses 12, and the amount of static charge will then be raised or lowered as desired to achieve an optimal amount of static charge using the various provided devices discussed above.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The exemplary embodiment was chosen and described in order to best explain the principles of the present disclosure and its practical application, to thereby enable others skilled in the art to best utilize the present disclosure and various embodiments with various modifications as are suited to the particular use contemplated.

What is claimed is:

1. A system for custom manufacturing a film to be temporarily applied to lenses of eyewear, the system comprising:
a measuring unit for measuring dimensions of the lenses;
a user-interface for receiving user input pertaining to desired properties of the film; and
a film-cutting unit for cutting the film according to the dimensions of the lenses.

2. The system according to claim 1 further comprising a control unit that is configured to receive the dimensions of the lenses from the measuring system, and transmit to the film-cutting system information pertaining to the dimensions of the lenses.

3. The system according to claim 1 further comprising a tray arranged in the measuring unit for receiving and holding the eyewear therein.

4. The system according to claim 1 further comprising a payment unit for receiving payment from a user.

5. The system according to claim 1 wherein the film is a multilayer film.

6. The system according to claim 1 wherein the measuring unit includes at least one camera and at least one light source.

7. The system according to claim 1 wherein the user-interface includes a touchscreen for receiving input from a user and displaying an output to the user.

8. The system according to claim 1 wherein the film is adhered electrostatically to the lenses of the eyewear.

9. The system according to claim 2 wherein the control unit includes a processor and a non-transitory memory including computer program code instructions.

10. The system according to claim 3 wherein the tray includes an eyewear-holding fixture.

11. The system according to claim 4 wherein the measuring unit includes at least one camera and at least one light source.

12. The system according to claim 6 wherein the light source is configured to provide any type of light selected from the group consisting of: visible light, infrared light, ultraviolet light, and combinations thereof.

13. The system according to claim 6 further comprising a control unit that is configured to receive the dimensions of the lenses from the measuring system, and transmit to the film-cutting system information pertaining to the dimensions of the lenses.

14. The system according to claim 13 further comprising a payment unit for receiving payment from a user.

15. The system according to claim 13 further comprising a tray arranged in the measuring unit for receiving and holding the eyewear therein.

16. The system according to claim 15 further comprising a payment unit for receiving payment from a user.

17. The system according to claim 6 further comprising a tray arranged in the measuring unit for receiving and holding the eyewear therein.

18. The system according to claim 17 further comprising a payment unit for receiving payment from a user.

19. The system according to claim 6 further comprising a payment unit for receiving payment from a user.
